(19) United States
(12) Patent Application Publication
(10) Pub. No.: US 2002/0188669 A1
(43) Pub. Date: Dec. 12, 2002

(54) Integrated method for disseminating large spatial data sets in a distributed form via the internet

(76) Inventor: Marc Jay Levine, Reston, VA (US)

Correspondence Address: E. Philp Koltos, Division of General Law, Office of the Solicitor, U.S. Department for the Interior, 1849 C Street NW, MS 6531, Washington, DC, 20240, US

(21) Appl. No.: 09/877,786

(22) Filed: Jun. 11, 2001

(51) Int. Cl. G06F 15/16

(52) U.S. Cl. 709/203; 707/104.1

(57) ABSTRACT

A method and an integrated software system is provided to manage, visualize and analyze geospatial data distributed across a network of computer servers. A plurality of servers, each executing specific software applications for performing various tasks, are integrated with one another so as to provide distributed processing of data mining and image data. A client computer is used to initiate a query request. The request is sent to at least one of the plurality of servers. The plurality of servers, through distributed processing, process the request. At least one of the plurality of servers returns a response to the query in the form at least one data set. The client computer then renders an image from the data set. In a further embodiment, multiple data sets are received from one or more of servers. The client computer then renders an image from the multiple data sets.

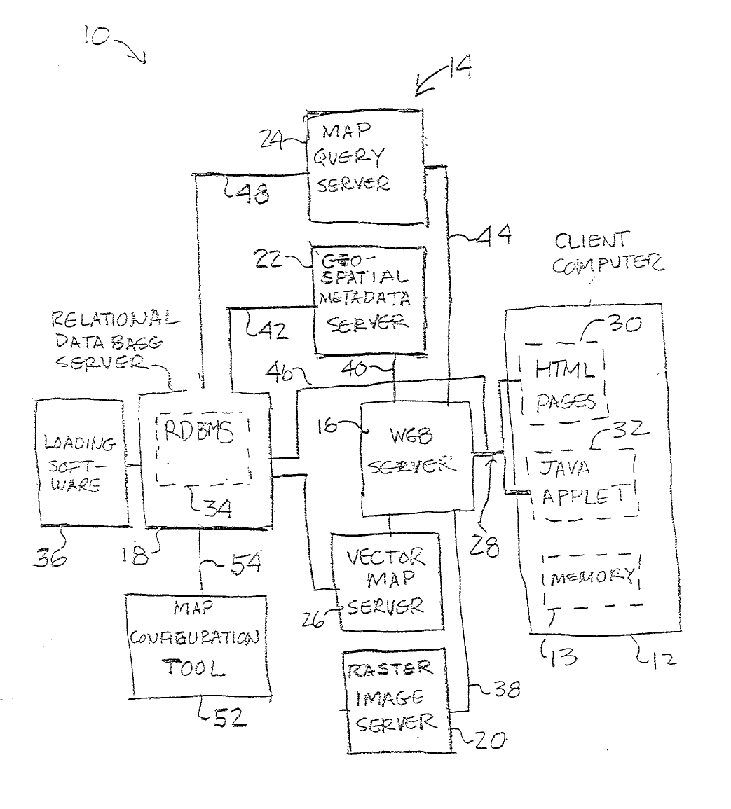

### ORIGIN OF THE INVENTION

This invention was made by employees of the United States Government and may be manufactured and used by or for the Government for governmental purposes without the payment of any royalties.

### BACKGROUND OF THE INVENTION

1. Field of the Invention

The present invention relates to a system and method for managing, visualizing, and analyzing image data, and in particular, a system and method of integrating a plurality of servers executing specific software applications to provide distributed processing of data mining and image data for the managing, visualizing, and analyzing image data initiated by a client computer.

2. Background of the Invention

Traditionally a graphical information system (GIS) has been used to collect and analyze various geographical data. The GIS provides visual simulations in rendering of geographic information as images from data stored in a database. A conventional GIS is a stand-alone system providing access to data contained therein by a user in relatively close proximity to the GIS (i.e., at a GIS workstation directly connected to a GIS processor).

A user performs data mining from the GIS by querying of a GIS database for a particular feature, attribute, or other data. GIS does not provide for wide networking (e.g. via a WAN or the Internet) due to the complexity of geospatial image processing and associated computation and the bandwidth necessary to provide desirable performance.

A disadvantage of present GISs is that such systems do not provide for sharing data stored in multiple databases for providing data mining or image processing. Typically, a GIS provides data mining of data stored only in its own database.

An additional disadvantage of a conventional GIS is that accessibility is limited to users who are in proximity of the GIS itself. As indicated above, due to the complexity of geospatial image processing and the computation and the bandwidth necessary to provide desirable results, widespread (i.e., wide networking such as the Internet) is not provided.

Limited geospatial image processing and analysis is currently available via various methods of disseminating maps across the Internet. The maps disseminated may comprise various map layers arranged in a hierarchical order. When these maps are laid one on top of another, a complete map may be displayed. These conventional methods include the creation of a display or graphic of either raster or vector data on a single server. The raster or vector data is then downloaded from the server to a client computer for display by an end user.

A disadvantage with conventional Internet disseminating map methods is that the user cannot modify or conduct spatial queries between spatial and attribute data which includes satellite imagery. In addition, a user cannot conduct GIS analysis, derive new data, or change the hierarchical order of the map layers.

### BRIEF SUMMARY OF THE INVENTION

The present invention relates to a method and system for integrating a plurality of applications running on multiple servers to provide distributed processing of data mining and image data for the managing, visualizing and analyzing geospatial image data initiated by a client computer. The client computer runs an application (e.g., a Java Applet) operatively associated with a web server. The web server is, in turn, networked to a plurality of processing servers. These processing servers, along with the web server, provide the distributed processing of the data mining and the image data which is downloaded to the client computer. The downloaded data may include both vector and raster data provided from one or more of the plurality of processing servers. The client computer may manipulate the downloaded data for visualization of spatial data and other geophysical/geographical data. The downloaded data may also include other attributes pertaining to the geophysical/geographical feature.

The invention, in one form thereof, concerns a system for managing, visualizing, and analyzing spatial data across a computer network comprising a plurality of processing servers. The plurality of processing servers are integrated with one another for providing at least one data set by distributive processing. The at least one data set comprises a respective plurality of data set values. A client computer is connected to the plurality of processing servers for transmitting a query request to the plurality of processing servers. In addition, the client computer receives and stores the at least one data set from the at least one of the plurality of processing servers. The client computer is adapted to render an image from the at least one data set and to manipulate the data set values of the at least one data set.

The invention, in another form thereof, concerns a method for managing, visualizing and analyzing geospatial across a computer network comprising transmitting a query request from a client computer to one of a plurality of processing servers integrated with one another. The method further includes providing at least one data set comprising a respective plurality of data set values by the plurality of servers functioning through distributive processing. The at least one data set is sent to the client computer and an image is rendered from the at least one data set by the client computer.

An object of the claimed invention is to provide for the distribution of large amounts of spatial and associated database information maintained, stored, or generated, on a plurality of computer servers.

Another object of the present invention is to provide data mining and visualization via geospatial metadata of various geospatial features and associated attributed data.

Yet another object of the present invention is to provide a system which allows a user to conduct spatial queries between spatial and attribute data, conduct GIS analysis, derive new data, and change the hierarchical order of map layers.

Further features and advantages of the present invention will be set forth in, or apparent from, the detailed description of preferred embodiments thereof which follows.

### BRIEF DESCRIPTION OF THE DRAWING

The invention will now be described in detailed with respect to preferred embodiments with reference to the accompanying drawings, wherein:

The single figure in the drawings is a schematic block diagram of a system for managing, visualizing and analyzing geospatial data across a computer network according to a preferred embodiment of the present invention.

### DETAILED DESCRIPTION OF THE INVENTION

Referring to the drawings, there is shown a geographical data system generally indicated by 10, including a client computer 12 and a plurality of processing servers 14. Client computer 12 includes a memory 13. The processing servers 14 include a web server 16, a relational database server 18, a raster image server 20, geospatial metadata server 22, map query server 24, and vector map server 26.

In a preferred embodiment, a distributed computer network formed by the relational database server 18, raster image server 20, geospatial metadata server 22, map query server 24, and vector map server 26 is deployed on a computer server device having the configuration: Sun Sparc Enterprise Server 5000, six 250 MHz CPU, two gigabytes RAM, one terabyte hard drive, and Sun Solaris 2.7 operating system.

The client computer 12 has the following minimum configuration: 166 MHz or above CPU, 64 MB RAM, and video capable of displaying at least 256 colors at 1024×768 (32K colors). If client computer 12 is an IBM PC compatible system, the client computer configuration further includes WINDOWS 95 or higher, Netscape 4.06 or newer or Netscape Communicator 4.51 or newer or MS Internet Explorer 4.01 Service Package 1 or newer. If client computer 12 is a Macintosh system, the minimum configuration includes MS Internet Explorer 4.5 or newer.

Client computer 12 is further configured with Java plug-in, Java Runtime Environment (JRE 1.2 (WINDOW), MRJ 2.2 (Macintosh)), which provides enhanced performance, memory management, and access to additional features e.g., layer transparency, create layer-buffer tool, and advanced layer editing, as described below.

Client computer 12 is connected to web server 16 via an Internet 28 connection indicated schematically at or other network connection. Client computer 12 includes HTML pages 30 and the Java Applet 32 which are downloaded from web server 16 across Internet connection 28 and deployed on client computer 12.

Client computer 12 enables a user to view image data (e.g. raster data) and vector data in the formats of maps and tables through the HTML Pages 30 and Java Applet 32. Java Applet 32 interacts with raster image server 20, geospatial metadata server 22, map query server 24, and vector map server 26 through conventional software running on web server 16 via the Internet 28 and the various Intranets connections shown.

HTML pages 30 provide an interface for end users to perform geospatial analysis. HTML pages 30 includes a main application page along with a setup page, a slideshow page and an index page which provides links to a help page.

The main application page provides links to a geospatial data application which will launch the Java applet 32. In addition, the main application page includes a detailed description page for each geographical available and provides an internal search engine. The main application page provides the flexibility of adding further functions and features easily by modifying the HTML script stored in web server 16.

The setup page of HTML pages 30 performs a checklist page to determine if client computer 12 is capable of running the geospatial data software such as Java applet 32. The checklist interrogates client computer 12 to determine the operating system, browser version, screen size, the presence or absence of Java-Runtime Environment plug-in, and Java permissions file. If any one of the requirements is not fulfilled, the user is altered (e.g., a red stop sign will be displayed). In addition, setup instructions are provided to assist a user in the setup procedure.

The slideshow page of HTML pages provides an overview of the geographical areas available for analysis. Included on the slideshow page is a presentation enhanced by JavaScript effects and a text description of each geographical area.

The help page provides an explanation of information about different sections of the website. The information includes: About, Explore, Feedback, Get Data, Setup, Using the Applet, FAQ and Contacting Us.

Relational database server 18 executes a relational database management systems (RDBMS) indicated at 34. RDBMS 34 may be any conventional, third party relational database. Spatial data is stored in RDBMS 34 in a shape file format. In addition, RDBMS 34 is spatial enabled (i.e. accommodates spatial data querying).

Two independent means may be employed to load spatial data to RDBMS 34. Spatial data can be loaded to RDBMS 34 using a third party's software, such as data loading utility 36. In additional, spatial data can be load directly to RDBMS 34.

During the data loading process, the data loading utility 36 reads the necessary global setting parameters for a map from RDBMS 34, builds the loading commands, calls the third party utilities and inserts the spatial and tabular data to the RDBMS 34. Spatial data is used to draw the map features (point, line and polygon). Tabular data includes nonspatial features associated with the spatial data. Data loading utility 36 allows for loading one data file or bulk loading many data files in a directory.

Raster image server 20 retrieves and sends georeferenced images to Java applet 32 through web server 16 and via Intranet 38 and Internet 28. Raster image server 20 provides for the visualization and analysis of a raster image along with other vector spatial data on client computer 12. Raster image server 20 supports multiple source file formats which include the MrSID, Geo Tiff, GIF, and JPEG images.

A MrSID image is a compressed file format that reduces the size of large high-resolution images to a certain ratio and maintains original image quality and integrity. Typically, a geographic area contains thousands of MrSID image mosaics compressed from other data sources such as U.S. Geological Survey Digital Orthophoto (DOQ) or shaded relief Digital Elevation Model (DEM). These MrSID images are georeferenced by a file in the shape file format.

Raster image server 20 includes an R-tree index file to facilitate the search and retrieve a desired MrSID image. A R-tree is a conventional indexing method linking an index entry to a corresponding MrSID image. Raster imager server 20 uses the R-tree index file to enhance the performance of searching geospatial data.

During operation, when a user wishes to zoom to an area to visualize images stored in a MrSID format, Java applet 32 sends the current map range to raster image server 20 via web server 16. Raster image server 20 queries the R-tree index file, locates the corresponding MrSID file names, and converts a geographic coordinate system to a image coordinate system.

After calculating the retrieval level, raster image server 20 retrieves Red Green Glue (RGB) values for the intersected area of each MrSID file using a conventional MrSID viewer library. Raster image server 20 then mosaics the MrSID images into one complete image. Finally, the complete image is sent to the Java applet 32 in JPEG or GIF format to be displayed along with other vector data.

The integration of MrSID images and a R-tree file allow raster image server 20 to retrieve and visualize very large (e.g., one terabyte) image data quickly. For example, the retrieval and visualization time of a terabyte of data using a 56K modem Internet interconnection and the geospatial data system 10 as configured above would be approximately 8 seconds.

Geospatial Metadata Server 22 provides users with data mining and decision support capability of geospatial metadata. Geospatial metadata is stored in RDBMS 34 and includes information pertaining to geospatial data such as images of the earth, maps and the geographical features that maps represent.

During operation, a user can input a query request in the form of key words using client computer 12 to search for map data related to a specific, search topic. The key words are sent to geospatial metadata server 22 through web server 16 via Internet 28 and Intranet 40. Upon receiving a search request, geospatial metadata server 22 accesses and queries RDBMS 34 via Intranet 42. Data pertaining to the search topic such as layer name, layer description, and available attribute data is downloaded to the Java applet 32 via Intranets 40, 42 and Internet 28. The user can use client computer 12 to select and display the resultant, downloaded data for future analysis and decision support activities.

Map query server 24 includes a CGI application written in C++ and embedded SQL. The map query server 24 provides for spatial analysis between image layers of a map displayed on client computer 12.

For example, map query server 12 can receives a spatial query request from the Java applet 32 for a spatial operation on two layers currently displayed in a map legend on client computer 12. The spatial query request is sent to map query server 24 through web server 16 via Internet 28 Intranet 44.

A typical spatial request would be in the form of URL:

http://webserver/cgi-bin/query?database=gulf

&relations={birds,lakes}

&attributes={birds.se_row_id}

&bbox=1-3728774,51879,3386977,5325159}

&where={within(birds.point,lakes.polygon)=1}

&condition={birds.name=‘Golden+Eagle’}

Map query server 24 parses the URL and constructs a SQL string that is passed to RDBMS 34. RDBMS 34 returns the se_row_id column, which is the unique identifier, for all features corresponding to a spatial query result. These identifiers are sent directly to Java applet 32 via Internet path 46.

Vector Map Server 26 is a third party vector display application and receives queried data from RDBMS 34, constructs the topology, then passes the data through the web server 26 to Java applet 32.

Java applet 32 is integrated with conventional, third party relational database software of RDBMS 34, for accomplishing the functions of spatial queries, attribute queries, mouse over and attribute display, display features attribute table display, highlighted features attribute table, buffering, data caching, save map as image, export feature attributes, and export highlighted feature attributes.

Spatial queries permit a user to observe relationships between map layers. A spatial query interface is provided on client computer 12 and consists of two drop down menu boxes containing the names of all map layers currently loaded and displayed in the map. Beside each layer is a graphical representation of the shape of the layer. Point layers have an image of points, line layers have an image of lines, and polygon layers have an image of polygons. Below the layer selections is the spatial relationship drop down menu. Only valid queries are listed in the drop down menu. Once a selection is made, images beside the drop down menu are used to illustrate a graphical example of the selected type of query.

There are four types of queries: intersects, contains, within and near. When a near query is selected, an input box is displayed underneath the query selection menu.

Valid spatial queries include point intersects point, point near point, point within line, point near line, point within polygon, point near polygon, line contains point, line near point, line within line, line intersects line, line contains line, line near line, line within polygon, line intersects polygon, line near polygon, polygon contains point, polygon near point, polygon intersects line, polygon contains line, polygon near line, polygon within polygon, polygon intersects polygon, polygon contains polygon, polygon near polygon.

During operation, when a spatial query is run, either Java applet 32 or web server 16 creates an URL that contains the name of the database, tables, and the spatial query and sends it to the map query server 24 via intranets 44, 48. The map query server executes the spatial query and returns the unique identifiers back to Java applet 32 via Internet path 46. The Java applet 32 uses the identifiers to locate the desired features and to highlight that the desired features on the map. These highlighted features remain on the map until another query is performed or the user clears them.

The mouse over function is used to display an attribute corresponding to a feature on the map. When the mouse cursor is moved over a feature on the map, if an attribute is associated with that feature (i.e. the mouse cursor position on the map), the corresponding attribute is display over the feature in a text box. The user can change the attribute that is displayed in the layer properties.

The display features attribute table displays the feature attributes of a layer in tabular format. Display feature attributes are downloaded from RDBMS 34 together with the vector data from vector map server 26 when a layer in the legend is displayed. The display feature attribute table only displays the features present in the displayed area of the current map area. Features that are not visible due to zooming or panning will not be displayed. The display feature table displays features one hundred at a time.

Java Applet 32 also employs server attributes that are downloaded separately from the vector data to minimize download time. The server attributes are downloaded from RDBMS server 34 and stored on client computer 12 in a server attributes table which provides a list of the visible feature identifiers. The visible feature identifiers are sent to vector map 26 and raster image server 20 to retrieve the server attributes.

The attribute table is interactive and responds to mouse clicks on the table rows. Clicking on a row highlights or unhighlights the row and the feature in the map for that row. This action is toggled.

A highlighted feature attribute table is similar to the display feature attribute table. However, only features that are currently highlighted in the map windows are displayed in the highlighted feature attributed table. Mouse interaction is inverted from the display feature attribute table. Clicking on a row highlights the row and unhighlights the feature in the map. This action is toggled.

Java applet 32 permits a user to perform attribute queries to select features according to features, themselves. For example, Java applet 32 can display all the currently displayed layers in the legend. Selecting a layer loads the available features into a drop down menu. When a feature is selected, a second drop down menu, namely a comparison type menu, is filled with the list of valid comparison query operations for that feature data type.

For string value features, comparison query operations are: is, is not, begins with, contains, and is in list. For numeric feature values, the possible operations are: is, is not, is greater than, is less than, is greater or equal to, is less than or equal to, is between, and is in list.

A text box for values is displayed beside the comparison type drop down menu. Values are entered in one of two ways. Users may manually enter the value in which they are interested in searching. A button also is located under the values text box that opens a window showing all the possible values for the selected feature.

Buffering draws a polygon of a specified distance around each feature in a layer. The buffer menu option opens a dialog box with a list of all currently displayed layers. The buffer distance is entered into a text box beside the list of layers. Buffer units are measured in either feet or miles using the available radio buttons. After selecting a layer, entering a buffer distance, and selecting the appropriate units, the buffer layer is created. A new layer is added to the legend directly under the buffered layer. By default, the new buffer layer is not displayed in the map. The new layer is drawn using transparency so that the original layer can be displayed underneath it. Buffer layers can be removed from the legend when no longer needed.

Data caching by Java applet 32 permits vector data to be downloaded only once. A simple caching mechanism is used to save vector data as the data is downloaded. Any future requests will be sent to memory or cache 13 of client computer 12 instead of the web server 16. The cache setting options are alterable to disable caching, change the cache directory, and delete cached files.

Client computer 12 can save a map as a GIF or JPEG image using conventional, third party, Java classes. All the currently displayed layers in the main map window are saved in the image. This image can be imported into a word processor, a graphics software package, or printed out.

Display feature attributes and export highlighted feature attributes can be saved to client computer 12 as a data file such as a comma-separated values (CSV) file. All features in the layer are exported to the data file.

A map configuration tool 52, which is an applet for creating configuration files, is connected to server 18 by an Intranet connection 54. The map configuration tool 52 performs the task of setting up maps, legend hierarchies, and layer properties.

Using map configuration tool 52, ESRI ArcView project files can be imported into RDBMS 34. A separate map is created for each view that exists in the ArcView file. Themes are added as new layers. A theme that contains classifications is created as a parent with children. Each child is given a SQL condition that is sent to RDBMS via Intranet connection 54 the third party server.

In addition, an ArcView legend file can also be applied to an existing layer. The layer is converted to a parent layer with the children created from the ArcView project file.

Although the invention has been described above in relation to preferred embodiments thereof, it will be understood by those skilled in the art that variations and modifications can be effected in these preferred embodiments without departing from the scope and spirit of the invention.

What is claimed is:

1. A system for managing, visualizing, and analyzing geospatial data across a computer network, said system comprising:
a plurality of processing servers integrated with one another for providing at least one data set by distributed processing, said at least one data set comprising a plurality of data set values; and
a client computer connectable to said plurality of processing servers for transmitting a query request to said plurality of processing servers, for receiving and storing said at least one data set from at least one of said plurality of processing servers, for rendering an image from said at least one data set, and for manipulating said data set values of said at least one data set.

2. The system of claim 1, wherein said query request comprises a request to view a geospatial feature and said image comprises said geospatial feature.

3. The system of claim 1, wherein said client computer is further for manipulating said values of said at least one data set.

4. The system of claim 3, wherein said image comprises superimposed multiple layers of subimages.

5. The system of claim 4, wherein each of said subimages rendered from one of said plurality of data sets.

6. The system of claim 1, wherein said at least one data set comprises a plurality of data sets and said image rendered from said plurality of data sets.

7. The system of claim 6, wherein said plurality of data sets are stored on a respective one of said processing servers.

8. The system of claim 1, wherein said client computer adapted to manipulate said data set values of said data set stored on said client computer to generate modified data set values.

9. The system of claim 8, wherein said imagine is rendered from said modified data set.

10. The system of claim 8, wherein client computer communicates with at least one of said plurality of processing servers such that said plurality of processing servers integrated with one another provide at least said modified data set.

11. The system of claim 1, wherein each said plurality of servers executes a respective server application, and the server applications executed by said servers being integrated with one another so as to provide said at least one data set.

12. The system of claim 11, wherein said plurality of servers comprises:
a host server connectable to said client computer and at least one other of said server of said plurality of servers;
a raster image server for retrieving and sending referenced graphic features to said host server;
a database server for maintaining a relational database, said database storing spatial data and tabular data;
a geospatial metadata server operatively connected to said database server for providing data mining of said database;
a map query server for receiving a spatial operation request from said client computer and for generating a map query request to said database server, thereby said database server returning unique identifiers for all features in said spatial operation request; and
a vector map server.

13. The system of claim 1, wherein said at least one data set comprises spatial data and attribute data.

14. A method of managing, visualizing, and analyzing geospatial data across a computer network, said method comprising:
transmitting a query request from a client computer to one of a plurality of processing servers integrated with one another;
using distributed processing to provide at least one data set comprising a plurality of data set values from at least one of the plurality of servers;
sending the at least one data set to the client computer; and
using the client computer to render an image from the at least one data set.

15. The method of claim 14, wherein the query request comprises a request to view a geospatial feature and the image comprises the geospatial feature.

16. The method of claim 14, wherein the at least one data set comprises a plurality of data sets and the image is rendered from the plurality of data sets.

17. The method of claim 16, said rendering the image comprises superimposed multiple layers of subimages.

18. The method of claim 17, wherein each of the subimages are rendered from one of the plurality of data sets.

19. The method of claim 14, further comprising:
storing the at least one data set by the client computer; and
manipulating the data set values of said at least one data set to generate modified data set values.

20. The method of claim 19, said rendering the image comprises rendering the image from said modified data set.

21. The method of claim 19, further comprising:
updating the data set values such that the plurality of servers will provide the modified data set values, if the query request is made again, by the client computer interacting with the plurality of server computers.

22. The method of claim 14, further comprising:
executing a respective server application on each of the plurality of servers; and wherein the server applications are integrated with one another for said providing the at least one data set.

23. The method of claim 22, wherein providing at least one data set comprising a respective plurality of data set values by the plurality of servers comprises:
maintaining and storing spatial data and tabular data in a relational database on a database server.

24. The method of claim 22, wherein providing at least one data set comprising a respective plurality of data set values by the plurality of servers comprises:
retrieving and sending referenced graphic features to a host server from a raster image server.

25. The method of claim 22, wherein providing at least one data set comprising a respective plurality of data set values by the plurality of servers comprises:
extracting data from the relational database using a geospatial metadata server, the geospatial metadata server accesses and provides queries to the database server.

26. The method of claim 22, wherein providing at least one data set comprising a respective plurality of data set values by the plurality of servers comprises:
sending a spatial operation request by the client computer;
receiving a spatial operation request sent by a map query server;
generating a map query request by the map query server;
transmitting the map query request to the database server; and
returning unique identifiers by the database server for all features in the spatial operation request.

27. The method of claim 22, wherein providing at least one data set comprising a respective plurality of data set values by the plurality of servers comprises:
maintaining and storing spatial data and tabular data in a relational database on a database server;
retrieving and sending referenced graphic features to a host server from a raster image server;
extracting data from the relational database using a geospatial metadata server, the geospatial metadata server accessing and providing queries to the database server;
sending a spatial operation request by the client computer;
receiving a spatial operation request sent by a map query server;
generating a map query request by the map query server;
transmitting the map query request to the database server; and
returning unique identifiers by the database server for all features in the spatial operation request.

28. The method of claim 14, wherein the at least one data set comprises spatial data and attribute data.
